(19) United States
(12) Patent Application Publication
(10) Pub. No.: US 2012/0092332 A1
(43) Pub. Date: Apr. 19, 2012

(54) INPUT DEVICE, INPUT CONTROL SYSTEM, METHOD OF PROCESSING INFORMATION, AND PROGRAM

(75) Inventors: Tsubasa Tsukahara, Tokyo (JP); Masatoshi Ueno, Kanagawa (JP); Shinobu Kuriya, Kanagawa (JP); Tetsuro Goto, Tokyo (JP); Hideo Kawabe, Saitama (JP); Toshiyuki Nakagawa, Kanagawa (JP); Kenichi Kabasawa, Saitama (JP)

(73) Assignee: Sony Corporation, Tokyo (JP)

(21) Appl. No.: 13/252,441

(22) Filed: Oct. 4, 2011

(30) Foreign Application Priority Data
Oct. 15, 2010 (JP) 2010-232469

(51) Int. Cl. G06F 3/045; G06F 3/033; G06T 15/00; G06F 3/041

(52) U.S. Cl. 345/419; 345/173; 345/174; 345/158

(57) ABSTRACT

An input device includes a housing having a two dimensional detection surface, a first detection unit detecting a position coordinate of a detection object that travels on the detection surface and outputting a first signal to calculate a travel direction and an amount of travel of the detection object, a second detection unit detecting gradient of the detection surface relative to one reference plane in a spatial coordinate system to which a screen belongs and outputting a second signal to calculate a tilt angle of the detection surface relative to the reference plane, and a control unit generating a control signal to three dimensionally control a display of an image displayed on the screen based on the first signal and the second signal.

### BACKGROUND

The present disclosure relates to an input device, an input control system, a method of processing information, and a program to operate an operation object displayed two dimensionally or three dimensionally.

For example, a mouse is widely used as an input device to operate a GUI (graphical user interface) displayed two dimensionally on a display. In recent years, many types of input devices that are of the spatial operation type have been proposed, not limited to input devices of the planar operation type typified by a mouse.

For example, Japanese Unexamined Patent Application Publication (Translation of PCT Application) No. 6-501119 discloses an input device that includes three acceleration meters to detect linear translational movement along three axes and three angular velocity sensors to detect three angular rotation of the axes and that detects sextic movement within the three dimensions. This input device detects the acceleration, the speed, the position, and the orientation of a mouse to transmit the detection signal to a computer, thereby enabling to control an image displayed three dimensionally.

### SUMMARY

However, this type of a spatial operation type input device has a problem of having lower operability in comparison with a planar operation type input device. The causes are that the acceleration sensors do not separate the gravitational acceleration from the movement acceleration, that numerical processing, such as integration of various sensor values, is prone to an error, and that a little motion of a person and the like are difficult to sense and prone to false detection. Accordingly, with a spatial operation type input device of the past, it was not easy to obtain a user intuitive operational feeling.

It is desirable to provide an input device, an input control system, a method of processing information, and a program that are excellent in operability and capable of obtaining a user intuitive operational feeling.

According to an embodiment of the present disclosure, there is provided an input device including a housing, a first detection unit, a second detection unit, and a control unit.

The housing has a two dimensional detection surface.

The first detection unit detects a position coordinate of a detection object that travels on the detection surface and outputs a first signal to calculate a travel direction and an amount of travel of the detection object.

The second detection unit detects gradient of the detection surface relative to one reference plane in a spatial coordinate system to which a screen belongs and outputs a second signal to calculate a tilt angle of the detection surface relative to the reference plane.

The control unit generates a control signal to three dimensionally control a display of an image displayed on the screen based on the first signal and the second signal.

In the input device, the control unit calculates the travel direction and the amount of travel of the detection object based on the first signal and calculates the tilt angle of the detection surface relative to the reference plane based on the second signal. The detection object is, for example, a finger of a user and the reference plane may include, for example, a horizontal ground plane. The control unit specifies a relative position of the detection surface relative to the screen based on the second signal and makes each direction of up, down, left, right, and depth of the screen and the direction of each axis within the detection surface correspond to each other. Then, the control unit three dimensionally controls a display of the image corresponding to the travel direction and the amount of travel of the detection object.

According to the input device, an image can be three dimensionally controlled by an orientation operation of a housing and a travel operation of a finger on a detection surface. This enables to enhance the operability and obtain a user intuitive operational feeling.

The detection object is not limited only to a finger of a user but also includes other operators, such as an input pen. The first detection unit is not particularly limited as long as it is a sensor capable of detecting the position coordinates of a detection object on a detection surface, and for example, touch sensors, such as those of capacitive type and resistive type, are used. As the second detection unit, acceleration sensors, geomagnetic sensors, angular velocity sensors, and the like are used, for example.

The reference plane is not limited to a plane vertical to the direction of gravity and may also be a plane parallel to the direction of gravity, for example, a plane parallel to the screen.

The image to be an operation object may be a two dimensional image and may also be a three dimensional image (real image and virtual image), and includes an icon, a pointer (cursor), and the like. A three dimensional control of the image display means a display control of an image along each direction of up, down, left, right, and depth of the screen, and includes, for example, a travel control of a pointer indicating a three dimensional video image along the three-axis directions, a display control of a three dimensional video image, and the like.

The detection surface typically has a first axis and a second axis orthogonal to the first axis. The second detection unit may also include an acceleration sensor outputting a signal corresponding to a tilt angle for an axial direction of at least one of the first axis and the second axis relative to a direction of gravity. This enables to easily obtain a detection signal corresponding to the tilt angle of the detection surface relative to the reference plane.

The acceleration sensors are typically arranged inside the housing respectively along a first axial direction, a second axial direction, and a third axial direction orthogonal to them, and the tilt angle of the detection surface relative to the reference plane is calculated based on the outputs of the acceleration sensors in the respective axial directions.

In a case that the image is a three dimensional video image displayed on the screen, the control signal may include a signal controlling magnitude of video image parallax of the three dimensional video image.

This enables an appropriate display control of a three dimensional video image along the depth direction of the screen.

According to another embodiment of the present disclosure, there is provided an input control system including an input device and an information processing device.

The input device has a housing, a first detection unit, a second detection unit, and a sending unit. The housing has a two dimensional detection surface. The first detection unit detects a position coordinate of a detection object travelling on the detection surface and outputs a first signal to calculate a travel direction and an amount of travel of the detection object. The second detection unit detects a tilt angle of the detection surface relative to one reference plane in a spatial coordinate system to which a screen belongs and outputs a second signal to calculate the tilt angle of the detection surface relative to the reference plane. The sending unit sends the first signal and the second signal.

The information processing device has a receiving unit and a control unit. The receiving unit receives the first signal and the second signal sent from the sending unit. The control unit generates a control signal to three dimensionally control a display of an image displayed on the screen based on the first signal and the second signal.

According to still another embodiment of the present disclosure, there is provided a method of processing information including to calculate, based on an output of a first detection unit detecting a position coordinate of a detection object travelling on a two dimensional detection surface, a travel direction and an amount of travel of the detection object.

Based on an output of a second detection unit detecting gradient of the detection surface relative to one reference plane in a spatial coordinate system to which a screen belongs, a tilt angle of the detection surface relative to the reference plane is calculated.

Based on the travel direction and the amount of travel of the detection object and the tilt angle of the detection surface relative to the reference plane, a display of an image displayed on the screen is three dimensionally controlled.

According to yet another embodiment of the present disclosure, there is provided a program that makes an information processing device execute the above method of input control. The program may be recorded in a recording medium.

According to embodiments of the present disclosure, it is possible to obtain a user intuitive operational feeling that is excellent in operability.

### BRIEF DESCRIPTION OF THE DRAWINGS

FIG. 1 is a schematic block diagram of an input control system according to an embodiment of the present disclosure;

FIG. 2 is a schematic block diagram of an input device according to the embodiment of the present disclosure;

FIG. 3 illustrates relationship between a local coordinate system that the input device has and a global coordinate system to which a screen belongs;

FIG. 4 illustrates gradient of the input device in each direction;

FIG. 5 is a schematic view illustrating an operational example of the input device;

FIG. 6 is a schematic view illustrating another operational example of the input device;

FIG. 7 illustrates a control flow of the input control system;

FIGS. 8A and 8B both illustrate behavioral examples of the input control system;

FIGS. 9A and 9B both illustrate other behavioral examples of the input control system;

FIGS. 10A and 10B both illustrate still other behavioral examples of the input control system;

FIG. 11 illustrates a control flow of an input control system according to another embodiment of the present disclosure;

FIG. 12 illustrates a behavioral example of an input control system according to still another embodiment of the present disclosure;

FIG. 13 illustrates another behavioral example of the input control system according to the still other embodiment of the present disclosure;

FIG. 14 illustrates still another behavioral example of the input control system according to the still other embodiment of the present disclosure; and

FIG. 15 illustrates a processing example of detecting a detection object using the input device.

### DETAILED DESCRIPTION OF EMBODIMENTS

With reference to the drawings, embodiments of the present disclosure are described below.

### Embodiment

### [Input Control System]

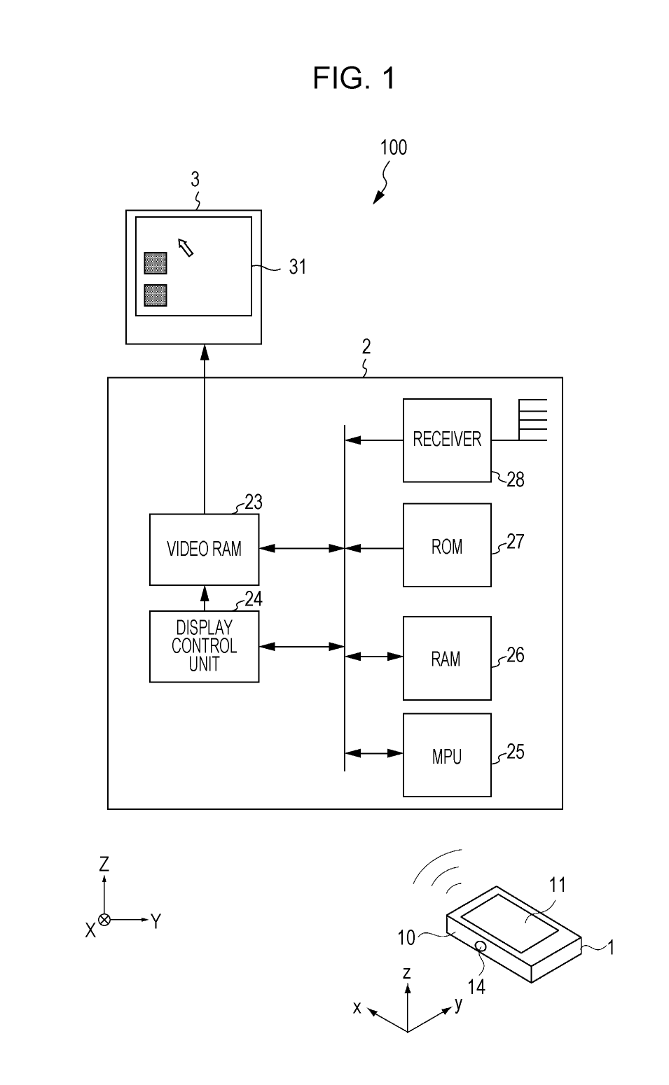

FIG. 1 is a block diagram showing an input control system according to an embodiment of the present disclosure. An input control system 100 of the embodiment has an input device 1, an image control device 2 (information processing device), and a display device 3.

The input control system 100 receives an operation signal sent from the input device 1 at the image control device 2 and controls an image displayed on a screen 31 of the display device 3 corresponding to the received operation signal. The screen 31 of the display device 3 has the depth direction in a direction of an X axis in the drawing, the horizontal direction in a direction of a Y axis, and the vertical direction (direction of gravity) in a direction of a Z axis, respectively.

Although the display device 3 may include, for example, a liquid crystal display, an EL (electro-luminescent) display, and the like, it is not limited to them. The display device 3 may also be a device integral with a display that can receive television broadcasting and the like. In the embodiment, the display device 3 is configured with, for example, a 3D television that is capable of displaying a three dimensional video image on the screen 31.

A description is given below to the input device 1 and the image control device 2.

### [Input Device]

The input device 1 has a housing 10 in a size allowing a user to grip. The housing 10 is approximately a perpendicular parallelepiped having the longitudinal direction in a direction of an x axis, the transverse direction in a direction of a y axis, and the thickness direction in a direction of a z axis, and a detection surface 11 is formed on one surface of the housing 10. The detection surface 11 belongs to a two dimensional coordinate system having coordinate axes on the x axis and the y axis orthogonal thereto and has a rectangular shape vertical to the z axis with a long side parallel to the x axis and a short side parallel to the y axis.

The input device 1 makes, for example, a finger of a hand of a user be a detection object, and has a function of detecting position coordinates of the finger on the detection surface 11 and a change thereof. This leads to obtain the travel direction, the travel speed, the amount of travel, and the like of the finger on the detection surface 11. The input device 1 further has a function of detecting the gradient of the detection surface 11 relative to the ground surface (XY plane). This enables to determine the orientation of the housing 10 in the operational space (XYZ space) and relative positional information of the detection surface 11 relative to the screen 31 is obtained.

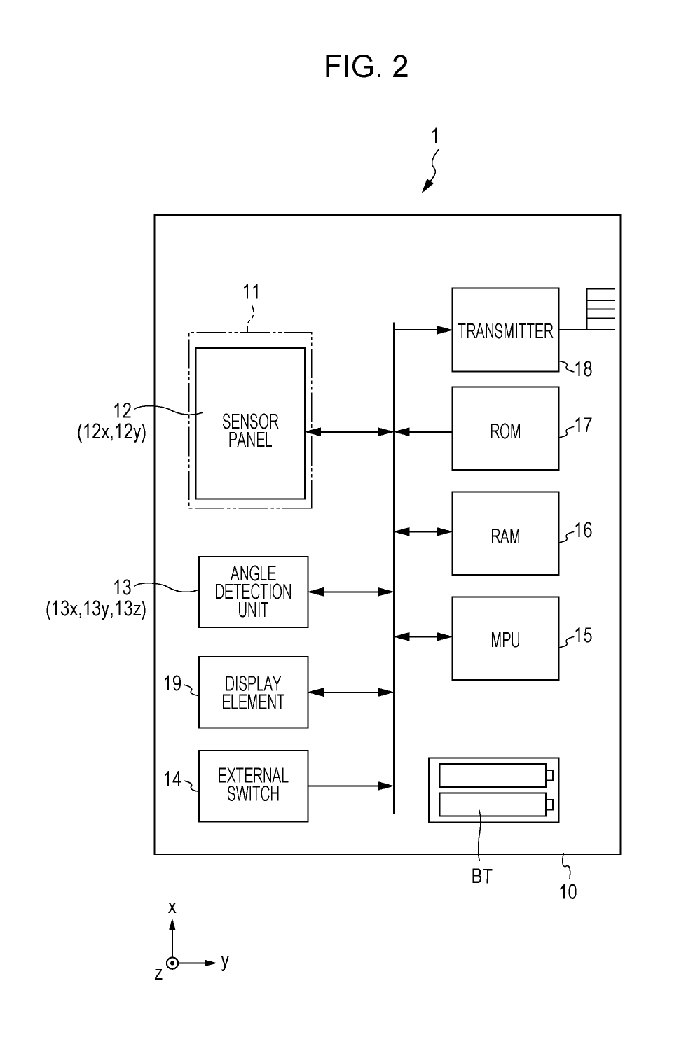

FIG. 2 is a block diagram showing an internal configuration of the input device 1. The input device 1 has the housing 10, a sensor panel 12 (first detection unit), an angle detection unit 13 (second detection unit), an external switch 14, a battery BT, an MPU 15 (control unit), a RAM 16, a ROM 17, and a transmitter 18 (sending unit).

The sensor panel 12 is formed in a shape and a size approximately identical to those of the detection surface 11. The sensor panel 12 is arranged immediately below the detection surface 11 to detect a detection object (finger) in contact with or in proximity to the detection surface 11. The sensor panel 12 outputs an electrical signal (first detection signal) corresponding to the position coordinates of the detection object on the detection surface 11.

In the embodiment, a touchscreen of a capacitance type used as the sensor panel 12 is capable of statically detecting a detection object in proximity to or in contact with the detection surface 11. The touchscreen of a capacitance type may be projected capacitive or may also be surface capacitive. This type of a sensor panel 12 typically has a first sensor 12x for x position detection in which a plurality of first wirings parallel to the y axis are aligned in the x axis direction and a second sensor 12y for y position detection in which a plurality of second wirings parallel to the x axis are aligned in the y axis direction, and these first and second sensors 12x and 12y are arranged facing each other in the z axis direction.

Other than the above, the touchscreen is not particularly limited as long as it is a sensor that can detect position coordinates of a detection object, and various types, such as a resistive film type, an infrared type, an ultrasonic wave type, a surface acoustic wave type, an acoustic wave matching type, and an infrared image sensor, are applicable.

The detection surface 11 may be configured with a portion of a wall forming a surface of the housing 10 and may also be configured with a plastic sheet or the like separately provided as a detection surface. Alternatively, the detection surface 11 may also be an opening in a rectangular shape formed in a portion of a wall of the housing 10, and in this case, a surface of the sensor panel 12 forms a portion of the detection surface 11. Further, the detection surface 11 and the sensor panel 12 may have optical transparency and may also have no optical transparency.

In a case that the detection surface 11 and the sensor panel 12 are formed with a material having optical transparency, a display element 19, such as a liquid crystal display and an organic EL display, may also be further arranged immediately below the sensor panel 12. This enables to display image information including characters and pictures on the detection surface 11.

The angle detection unit 13 detects the gradient of the detection surface 11 relative to one reference plane in a spatial coordinate system to which the display device 3 belongs. In the embodiment, the reference plane is defined as a horizontal ground surface (XY plane). The angle detection unit 13 outputs an electrical signal (second detection signal) to calculate a tilt angle of the detection surface 11 relative to the reference plane.

In the embodiment, the angle detection unit 13 is configured with a sensor unit to detect an angle about at least one axis of the x axis, the y axis, and the z axis of the housing 10. The angle detection unit 13 detects a tilt angle in at least one axial direction of the x axis, the y axis, and the z axis relative to the direction of gravity to output a detection signal corresponding to the tilt angle.

The angle detection unit 13 is configured with a three-axis acceleration sensor unit having an x axis acceleration sensor 13x that detects the acceleration in the x axis direction, a y axis acceleration sensor 13y that detects the acceleration in the y axis direction, and a z axis acceleration sensor 13z that detects the acceleration in the z axis direction. The angle detection unit 13 may also be configured with other sensors other than acceleration sensors, such as angular velocity sensors and geomagnetic sensors, for example.

Based on the first detection signal outputted from the sensor panel 12 and the second detection signal outputted from the angle detection unit 13, the MPU 15 performs various types of operational processing for determination of the orientation of the housing 10 and generation of a predetermined control signal.

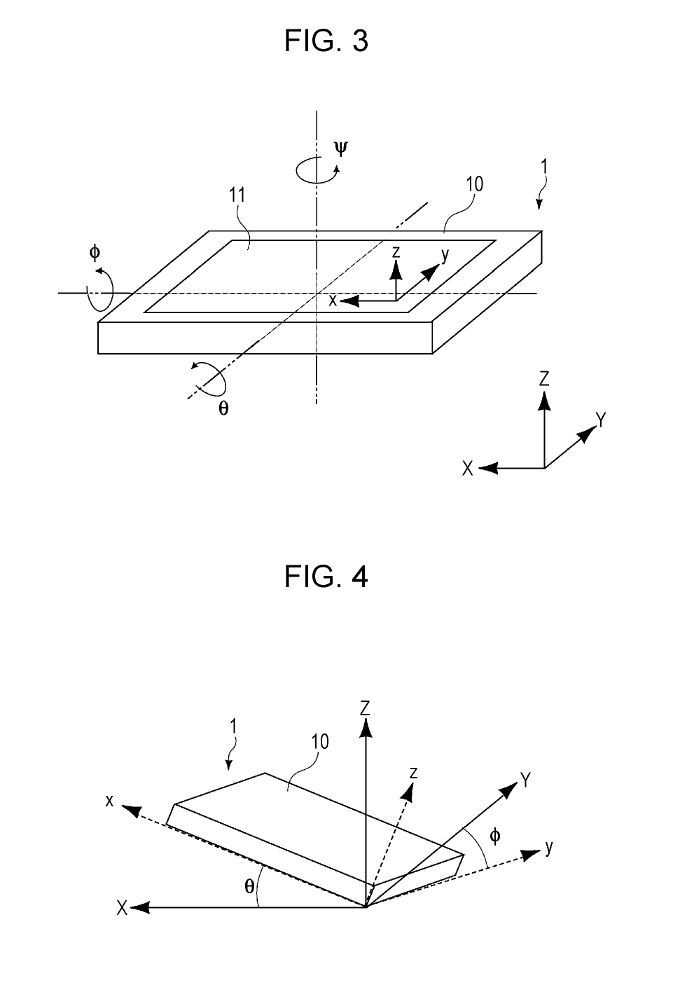

FIG. 3 illustrates the relationship between the XYZ coordinate system to which the display device 3 belongs (hereinafter, may also be referred to as a global coordinate system) and the xyz coordinate system that the housing 10 has (hereinafter, may also be referred to as a local coordinate system). In the drawing, a state is shown in which the local coordinate system and the global coordinate system correspond to each other. In the embodiment, a rotation angle of the housing 10 about the x axis relative to the XY plane is defined as φ and a rotation angle about the y axis relative to the XY plane as θ, respectively. A rotation angle about the z axis is defined as ψ.

The angles φ and θ are calculated respectively by an arithmetic operation using a trigonometric function of the outputs of the x axis direction acceleration sensor 13x, the y axis direction acceleration sensor 13y, and the z axis direction acceleration sensor 13z. That is, based on the outputs of each acceleration sensor, the MPU 15 calculates the respective tilt angles of the detection surface 11 relative to one reference plane (XY plane) in the global coordinate system, thereby calculating the angles φ and θ. In a case of calculating only either one of the angles φ and θ, a tilt angle relative to the direction of gravity may be calculated either one axial direction of the x axis or the y axis.

FIG. 4 illustrates a state of the housing 10 tilted at the angle θ about the y axis and at the angle φ about the x axis relative to the reference plane (XY plane). Outputs of the respective acceleration sensors 13x, 13y, and 13z of the angle detection unit 13 are outputted taking the x, y, and z directions as the respective positive direction. Here, the magnitude of the signals (voltages) of the respective acceleration sensors 13x, 13y, and 13z are defined as Ax, Ay, and Az, respectively, and the magnitude of the signals (voltages) of the acceleration sensors 13x and 13y relative to the gravity of 1 G are defined as A and B, respectively.

At this point, the magnitude of the angle θ relative to the ground surface (XY plane) is calculated from, for example, the arithmetic expressions of:

when Ax<0 and Az>0, θ=−arc sin(Ax/A) (1);

when Ax<0 and Az<0, θ=180+arc sin(Ax/A) (2);

when Ax>0 and Az<0, θ=180+arc sin(Ax/A) (3); and

when Ax>0 and Az>0, θ=360−arc sin(Ax/A) (4).

The magnitude of the angle φ relative to the ground surface (XY plane) is calculated from, for example, the arithmetic expressions of:

when Ay<0 and Az>0, φ=−arc sin(Ay/B) (5);

when Ay<0 and Az<0, φ=180+arc sin(Ay/B) (6);

when Ay>0 and Az<0, φ=180+arc sin(Ay/B) (7); and

when Ay>0 and Az>0, φ=360−arc sin(Ay/B) (8).

The MPU 15 determines the orientation of the housing 10 relative to the reference plane (XY plane) by the operational processing as mentioned above.

Although an example of determining the orientation of the housing 10 using the ground surface (XY plane) as the reference plane is described above, this description is substantially synonymous with determination of the orientation of the housing 10 using a plane parallel to the direction of gravity (Z axis direction) as a reference plane. Accordingly, in the description below, a description on the basis of the ground surface (XY plane) includes a description on the basis of the direction of gravity and a description on the basis of the direction of gravity includes a description on the basis of the ground surface (XY plane) unless otherwise specified.

The MPU 15 has an operation unit and a signal generation unit. The operation unit calculates the angles θ and φ. The signal generation unit generates a control signal corresponding to a travel direction of a detection object on the detection surface 11 based on the orientation of the housing 10 determined from the angles θ and φ.

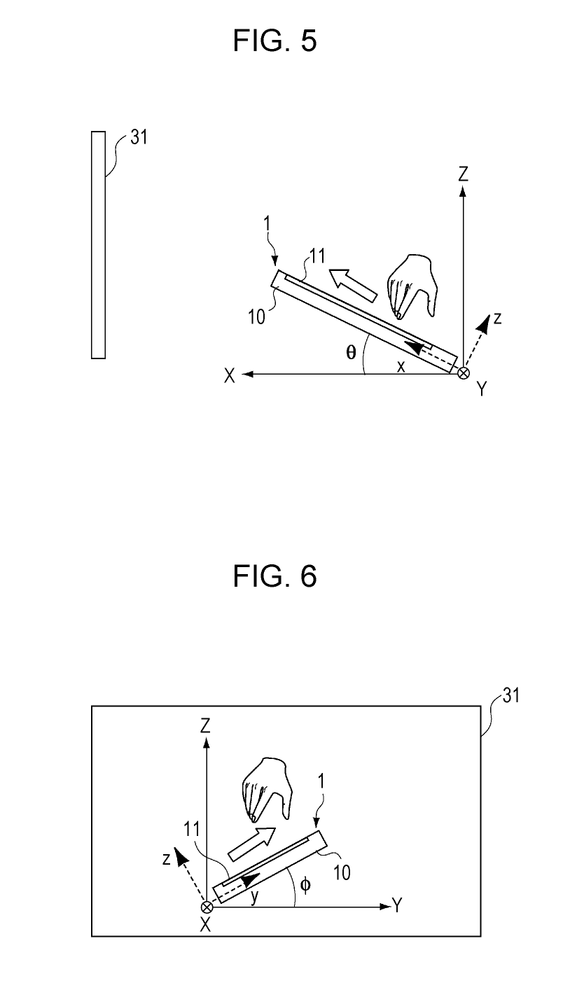

The operation unit also calculates the travel direction and the amount of travel of a detection object on the detection surface 11, respectively. For example, as shown in FIGS. 5 and 6, cases are considered that the detection surface 11 of the housing 10 is operated in a state of being tilted relative to the reference plane (XY plane). In these examples, the operation unit calculates the tilt angles θ and φ, respectively, relative to the reference plane (XY plane) of the x axis and the y axis of the housing 10 based on the outputs of the respective acceleration sensors 13x, 13y, and 13z of the angle detection unit 13.

For example, in a case of making a detection object (finger) travel by a distance D in the x direction on the detection surface 11 as shown in FIG. 5, an amount D1 of travel along the depth direction (X axis direction) of the screen 31 and an amount D2 of travel along the vertical direction (Z axis direction) of the screen are calculated as below, respectively.

D1=D×cos θ (9)

D2=D×sin θ (10)

Similarly, in a case of making a detection object (finger) travel by a distance L in the y direction on the detection surface 11 as shown in FIG. 6, an amount L1 of travel along the horizontal direction (Y axis direction) of the screen 31 and an amount L2 of travel along the vertical direction (Z axis direction) of the screen are calculated as below, respectively.

L1=L×cos φ (11)

L2=L×sin φ (12)

The signal generation unit generates a control signal to control a display of an image along the depth direction of the screen 31 based on the tilt angle in the amount of travel and the travel direction of the detection object calculated in the operation unit. That is, the signal generation unit generates a control signal for a three dimensional control of displaying an image to be displayed on the screen 31 based on the tilt angle in the amount of travel and the travel direction of the detection object calculated in the operation unit.

The three dimensional control of the image to be displayed on the screen 31 includes, for example, a travel control in the respective directions of up, down, left, right, and depth of a three dimensional video image displayed on the screen 31, a pointer (cursor) to indicate a three dimensional video image, and the like. It may also be a travel control of a two dimensional image displayed on the screen 31, and in this case, the control of the depth direction of the screen may include a zoom control of the image. The control signal may also include a signal for a control of an image to be displayed on the display element 19.

The input device 1 may also have the external switch 14, further. The external switch 14 is, for example, mounted on a side surface of the housing 10 as shown in FIG. 1. The external switch 14 detects a pressing operation by a user to generate a signal (third detection signal) corresponding to the pressing operation. The “signal corresponding to a pressing operation” may include signals, such as the presence or absence of pressing, the magnitude of a pressing force, the pressing time period, and the like. The signal generation unit of the MPU 15 generates a control signal (second control signal) corresponding to the pressing operation of the external switch 14 to enable a more expansive image display control.

The external switch 14 may also function as, for example, a key for selection or execution of an image indicated by the pointer. This enables an operation, such as drag and drop. By placing external switches 14 on both side surfaces of the housing 10, it can also function as click keys for right clicks/left clicks and the like. The location, the number, the shape, and the like of the external switch(s) 14 are not particularly limited and can be set appropriately.

Meanwhile, the MPU 15 may also include a driving circuit to drive the sensor panel 12 and the angle detection unit 13. In the sensor panel 12, a signal current is supplied in order from the driving circuit to the first and second wirings to output a detection signal corresponding to the position coordinates of the detection object. The MPU 15 receives the detection signal from the sensor panel 12 to calculate the position coordinates, the change in the position coordinates, the track of the position coordinates, and the like of the detection object on the detection surface 11. The type of detection is not particularly limited, and it may be a mutual type in which the position coordinates of the detection object are detected based on the change in capacitance between the wirings and may also be a self type in which the position coordinates of the detection object is detected based on the change in capacitance between the wirings and the detection object.

The MPU 15 may also include an A/D converter to convert each detection signal to a digital signal. The RAM 16 and the ROM 17 are used for a variety of operations by the MPU 15. The ROM 17 is configured with, for example, a non-volatile memory and stores a program and a setting value to make the MPU 15 execute various operational processing.

The transmitter 18 sends the predetermined control signal generated by the MPU 15 to the image control device 2. The battery BT configures a power supply for the input device 1 and supplies desired power to each unit inside the housing 10. The battery BT may be a primary cell and may also be a secondary cell. The battery BT may also be configured with a solar cell.

### [Image Control Device]

The image control device 2 has, as shown in FIG. 1, a video RAM 23, a display control unit 24, an MPU 25, a RAM 26, a ROM 27, and a receiver 28.

The receiver 28 receives the control signal sent from the input device 1. The MPU 25 analyzes the control signal and carries out various types of operational processing using various setting values and programs stored in the RAM 26 and the ROM 27. The display control unit 24 generates screen data mainly to display on the screen 31 of the display device 3 corresponding to the control of the MPU 25. The video RAM 23 becomes a work area of the display control unit 24 and temporarily stores the generated screed data.

The image control device 2 may be a device dedicated to the input device 1 and may also be a general information processing device, such as a PC (personal computer). The image control device 2 may also be a computer integral with the display device 3. Devices subjected to a control by the image control device 2 may also be an audio/visual device, a projector, a gaming device, a car navigation system, and the like.

The sending and receiving of a signal between the transmitter 18 of the input device 1 and the receiver 28 of the image control device 2 may be wireless communication and may also be wired communication. The method of transmitting a signal is not particularly limited, and may also be communication between devices, such as ZigBee® and Bluetooth®, and may also be communication through the internet.

The transmitter 18 may also be configured to be capable of receiving a signal from another device, such as the image control device 2. The receiver 28 may also be configured to be capable of sending a signal to another device, such as the input device 1.

### [Behavioral Example of Input Control System]

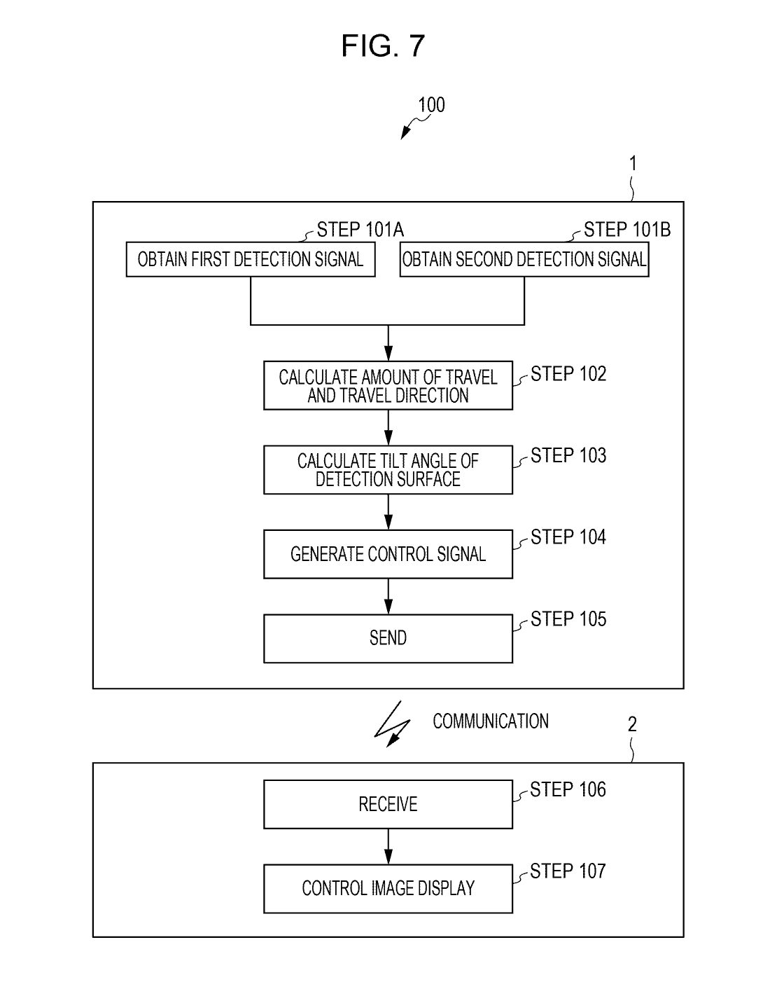

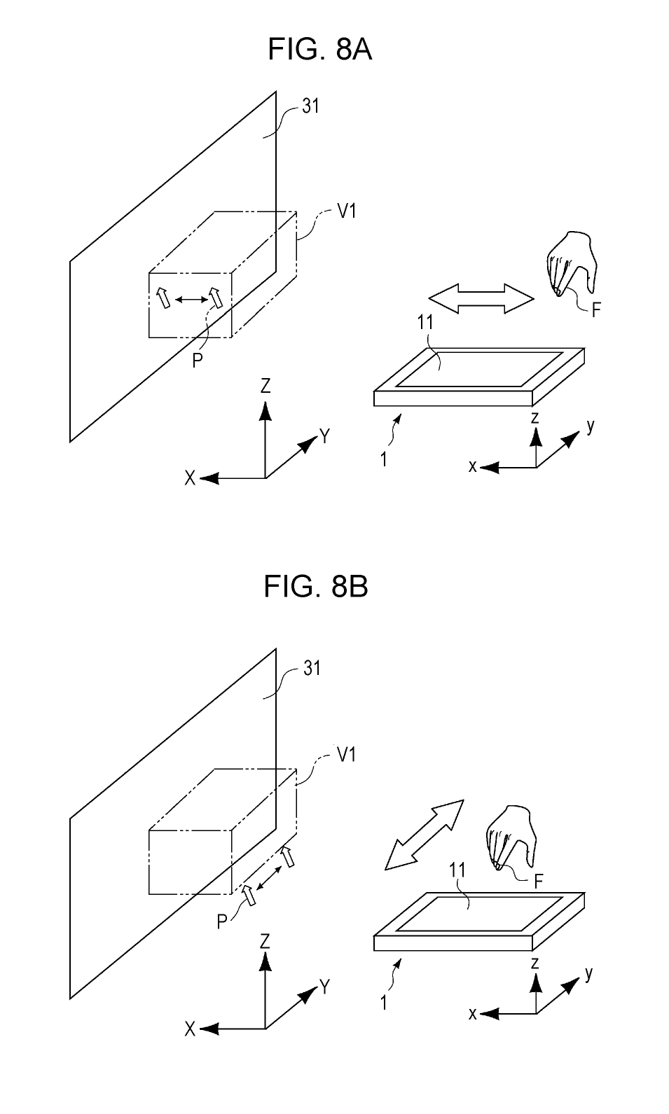

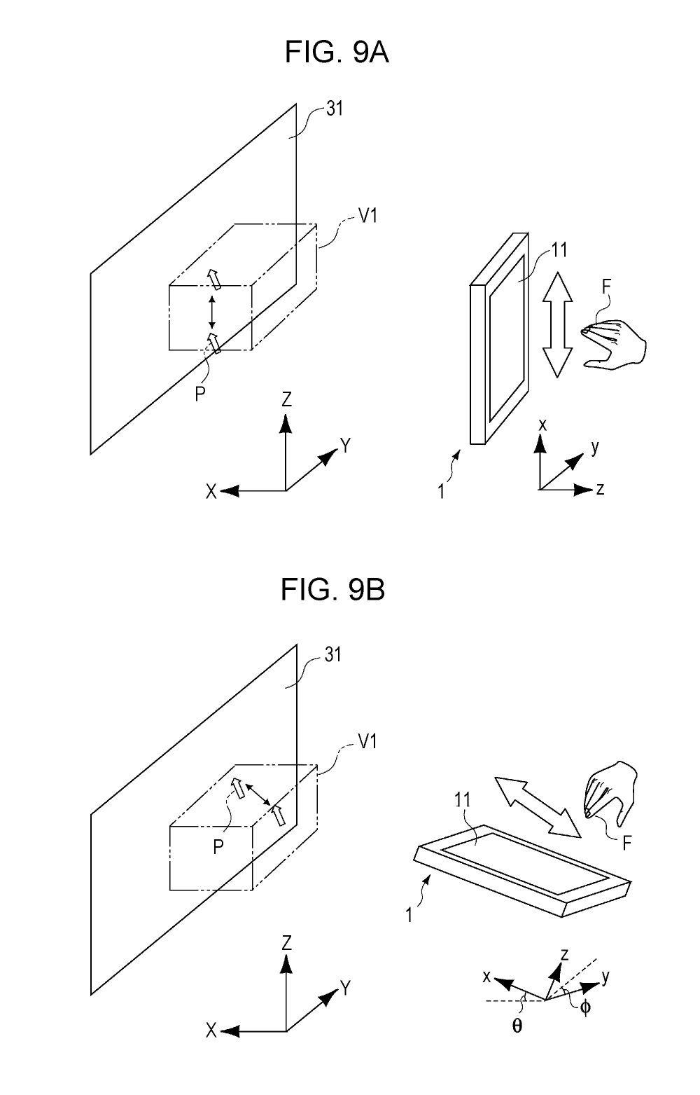

Next, a description is given to a basic behavioral example of the input control system 100. FIG. 7 illustrates a basic behavioral flow of the input device 1 and the image control device 2. FIGS. 8A and 8B and FIGS. 9A and 9B illustrate typical behavioral examples of the input control system 100. In this section, a description is given to a travel control, by the input device 1, of a pointer P that indicates an image (video image) V1 three dimensionally displayed on the screen 31.

The input device 1 detects the position coordinates of a finger (detection object) of a user on the detection surface 11 using the sensor panel 12 and outputs a first detection signal to calculate the travel direction and the amount of travel of the finger. Further, the input device 1 detects the gradient of the housing 10 relative to the reference plane (XY plane) using the angle detection unit 13 and outputs a second detection signal to calculate the tilt angle of the detection surface 11 relative to the reference plane. The MPU 15 of the input device 1 obtains the first detection signal outputted from the sensor panel 12 and the second detection signal outputted from the angle detection unit 13, respectively (steps 101A and 101B). The order of obtaining each detection signal is not limited and each detection signal may also be obtained simultaneously.

Based on the first and second detection signals, the MPU 15 calculates the amount of travel and the travel direction of the finger on the detection surface 11 and the tilt angle of the detection surface 11 relative to the reference plane (steps 102 and 103). The order of calculating the amount of travel of the finger and the like (step 102) and calculating the tilt angle of the detection surface 11 (step 103) is not particularly limited and they may also be calculated simultaneously.

Based on the temporal change in the position coordinates of the finger on the detection surface 11, the MPU 15 calculates the travel direction and the amount of travel of the finger on the detection surface 11. The travel speed and the positional track of the finger may also be calculated simultaneously. Based on the output of each acceleration sensor of the angle detection unit 13, the MPU 15 calculates the tilt angle of the detection surface 11 relative to the reference plane in a method of operation as shown in the expressions (1) through (8) above. Here, the tilt angle of the detection surface 11 relative to the reference plane includes the tilt angle φ of the detection surface about the x axis and the tilt angle θ about the y axis. The order of calculating the angles φ and θ is not particularly limited and they may also be calculated simultaneously.

For example, as shown in FIGS. 8A and 8B, in a case that the detection surface 11 of the input device 1 is approximately parallel to the reference plane (XY plane), the angles φ and θ become 0 degrees, respectively. In contrast, as shown in FIG. 9A, in a case that the detection surface 11 is approximately vertical to the reference plane (XY plane), the angle φ becomes 0 degrees and the angle θ becomes 90 degrees. Further, as shown in FIG. 9B, in a case that the detection surface 11 is tilted relative to the reference plane (XY plane), the tilt angles become predetermined angles φ and θ, respectively. In the examples shown in FIGS. 8A and 8B and FIGS. 9A and 9B, the detection surface 11 is directed above and the x direction of the detection surface 11 is directed to the screen 31.

Next, based on the travel direction and the amount of travel of a finger F on the detection surface 11 and the tilt angles φ and θ of the detection surface 11 relative to the reference plane, the MPU 15 generates a control signal to three dimensionally control a display of an image to be displayed on the screen 31 (step 104). That is, based on the angles φ and θ calculated in a method of operation as shown in the expressions (9) through (12) above, the MPU 15 makes each axial direction of up, down, left, right, and depth of the screen 31 and each axial direction of the detection surface 11 correspond to each other. Then, the MPU 15 generates a control signal to three dimensionally control the display of the pointer P corresponding to the travel direction and the amount of travel of the finger F.

For example, as shown in FIGS. 8A and 8B, in a case that the detection surface 11 is horizontal, the MPU 15 conforms the local coordinate system (xyz coordinate system) of the housing 10 to the global coordinate system (XYZ coordinate system) to which the screen 31 belongs. Then, as the user moves the finger F in the x axis direction on the detection surface 11 (FIG. 8A), the MPU 15 generates a control signal to make the pointer P travel in the depth direction (X axis direction) of the screen 31. Similarly, as the user moves the finger F in the y axis direction on the detection surface 11 (FIG. 8B), the MPU 15 generates a control signal to make the pointer P travel in the horizontal direction (Y axis direction) of the screen 31.

In contrast, as shown in FIG. 9A, in a case that the detection surface 11 is vertical to the reference plane (XY plane), the MPU 15 conforms the x axis direction of the housing 10 to the vertical direction (Z axis direction) of the screen 31 and the y axis direction of the housing 10 to the horizontal direction (Y axis direction) of the screen 31, respectively. Then, as the user moves the finger F in, for example, the x axis direction on the detection surface 11, the MPU 15 generates a control signal to make the pointer P travel in the vertical direction (Z axis direction) of the screen 31.

Further, as shown in FIG. 9B, in a case that the detection surface 11 is tilted at the angles of φ and θ relative to the reference plane (XY plane), the MPU 15 conforms the cosine (cos θ) direction of the x axis to the depth direction (X axis direction) of the screen 31 and conforms the cosine (cos φ) direction of the y axis to the horizontal direction (Y axis direction) of the screen 31. Then, as the user moves the finger F in, for example, the x axis direction on the detection surface 11, the MPU 15 generates a control signal to make the pointer P travel in the depth direction (X axis direction) and the vertical direction (Z axis direction) of the screen 31 based on the expressions (9) and (10).

The MPU 15 sends the control signal to the image control device 2 via the transmitter 18 (step 105). The image control device 2 receives the control signal via the receiver 28 (step 106). The MPU 25 analyzes the received control signal to supply a display control signal for controlling the travel of the pointer P to the display control unit 24, thereby controlling the travel of the pointer P on the screen 31 (step 107).

After the pointer P has travelled to a desired position, an object, such as an icon indicated by the pointer P, is selected by a pressing operation of the external switch 14. This selection signal is generated in the MPU 15 of the input device 1 as a second control signal and is sent to the image control device 2. An operation of selecting an icon is not limited to pressing operation of the external switch 14 and may also be, for example, a long pressing operation or a tapping operation on the detection surface 11.

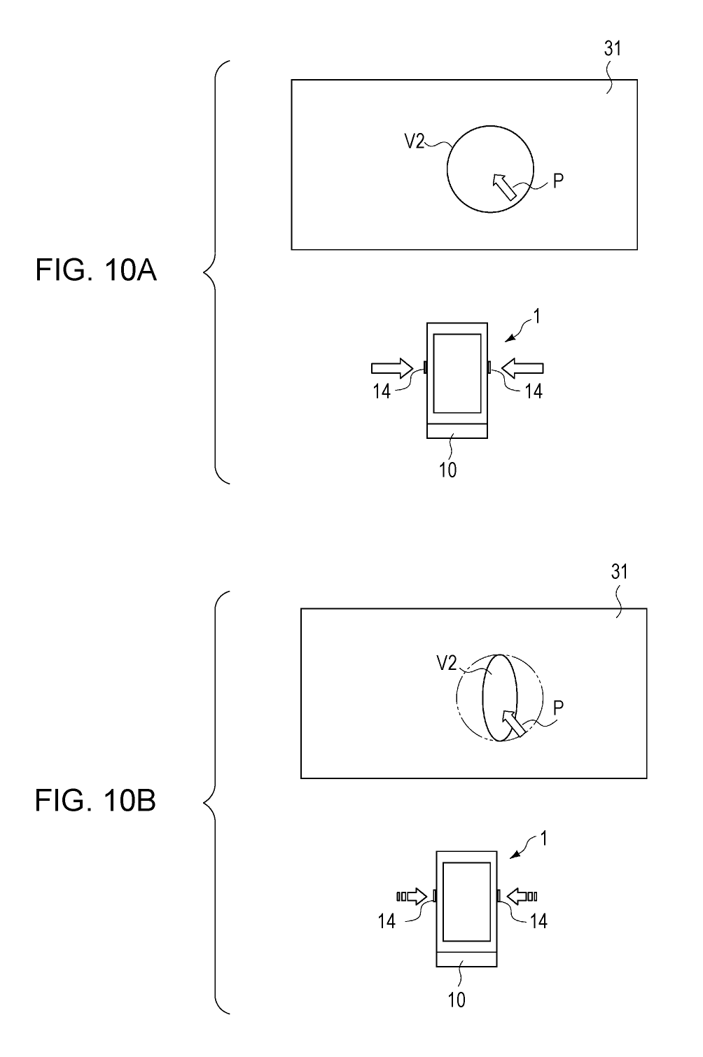

The external switch 14 can be used not only for an operation of selecting an icon but also for an operation of dragging an icon. For example, as shown in FIG. 10A, a behavior equivalent to the operation of dragging an image V2 may also be enabled by, after making the pointer P travel to a position of displaying the image V2 on the screen 31, simultaneously pressing the external switches 14 arranged on both sides of the housing 10. In addition, by using a sensor capable of detecting the pressing force (amount of press) stepwise as the external switch 14, the display of the image V2 can be changed corresponding to the amount of pressing the external switch 14. For example, as shown in FIG. 10B, an image display control is possible, such as large deformation of the image V2 in proportion to the pressing force of the external switch 14. The above description is not limited to the example of arranging the external switches 14 on both sides of the housing 10 and is applicable to an example of arranging the external switch 14 on only one side of the housing 10.

As thus described, the input control system of the embodiment can three dimensionally control an image displayed on the screen 31 by an operation of the orientation of the housing 10 and an operation of travelling the finger on the detection surface 11. According to the embodiment, it is possible to obtain a user intuitive operational feeling that is high in operability.

### Another Embodiment

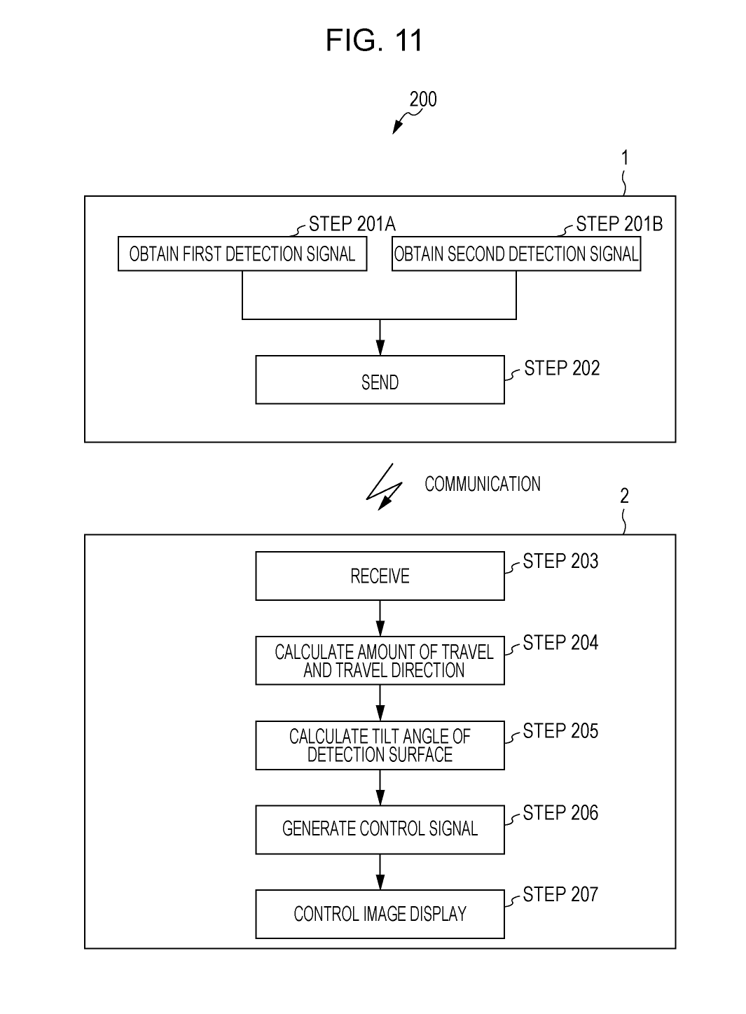

FIG. 11 illustrates a control flow of an input control system according to another embodiment of the present disclosure. In the other embodiment, the description is omitted or simplified for the parts similar to the configuration and the action of the previous embodiment and a description is given focusing the parts different from the previous embodiment.

An input control system 200 of the embodiment is different from the previous embodiment mentioned above in that a control signal to three dimensionally control the display of an image to be displayed on the screen is generated in the MPU 25 of the image control device 2. That is, in the input control system 200 of the embodiment, the MPU 15 of the input device 1 sends a first detection signal and a second detection signal obtained from the sensor panel 12 and the angle detection unit 13 respectively to the image control device 2 (steps 201A, 201B, and 202). Based on the received first and second detection signals, the MPU 25 of the image control device 2 calculates the travel direction and the amount of travel of the detection object (finger) on the detection surface 11 and the tilt angle of the detection surface 11 relative to the reference plane, respectively, (steps 204 and 205) to generate a control signal for the display control of an image (steps 206 and 207).

The MPU 25 of the image control device 2 executes respective processing of steps 203 through 207 based on a program stored in the ROM 27, for example. This control program may be downloaded via a communication cable connected to the image control device 2, for example, and may also be loaded from various types of recording medium.

According to the embodiment, complex operational processing, such as calculation of the travel direction and the amount of travel of a finger on the detection surface 11 and further calculation of the tilt angle of the detection surface 11 relative to the reference plane, can be executed by the image control device 2. Accordingly, the input device 1 may send only the information desired for the generation of a control signal, so that it is possible to seek simplification of the configuration, cost reduction, and power saving of the MPU 15.

### Still Another Embodiment

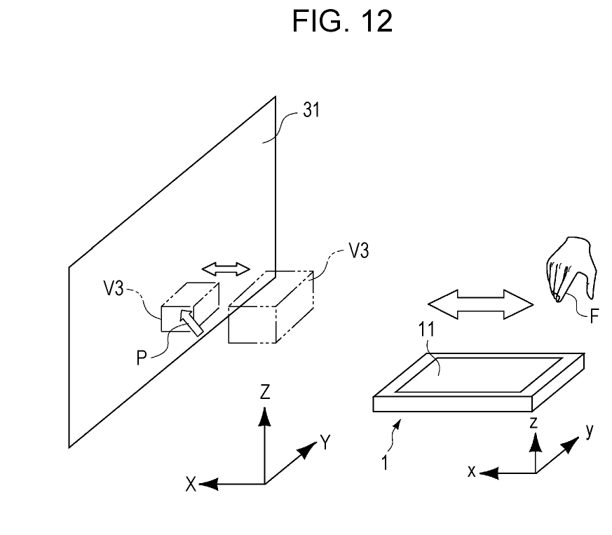

FIGS. 12 through 14 illustrate still another embodiment of the present disclosure. In the still other embodiment, the description is omitted or simplified for the parts similar to the configuration and the action of the embodiment described first and a description is given focusing the parts different from the embodiment described first.

In the embodiment, a description is given to a display control of a three dimensional video image using the input device 1. As shown in FIG. 12, it is assumed that the pointer P is overlapped on a three dimensional video image V3 on the screen 31 to be brought into a mode allowing an operation. In this state, as shown in the drawing, when making the finger F travel along the x axis direction on the detection surface 11 of the input device 1 kept in a horizontal orientation, the video image V3 is displayed as it moves in the depth direction of the screen 31. That is, the video image V3 travels in the back direction (+X direction) of the screen 31 as the finger F is made to travel in the +x direction, and on the contrary, the video image V3 travels in the front direction (−X direction) of the screen 31 as the finger F is made to travel in the −x direction.

A mode is shifted to the travel operation mode of the video image V3 by, for example, a pressing operation of the external switch 14 in a state where the pointer P is overlapped on the video image V3 or by a long press or tapping operation of the finger F on the detection surface 11. The display of the video image V3 travelling in a vertical or horizontal direction is similar to the travel operation of the pointer P mentioned above, so that the description is omitted here.

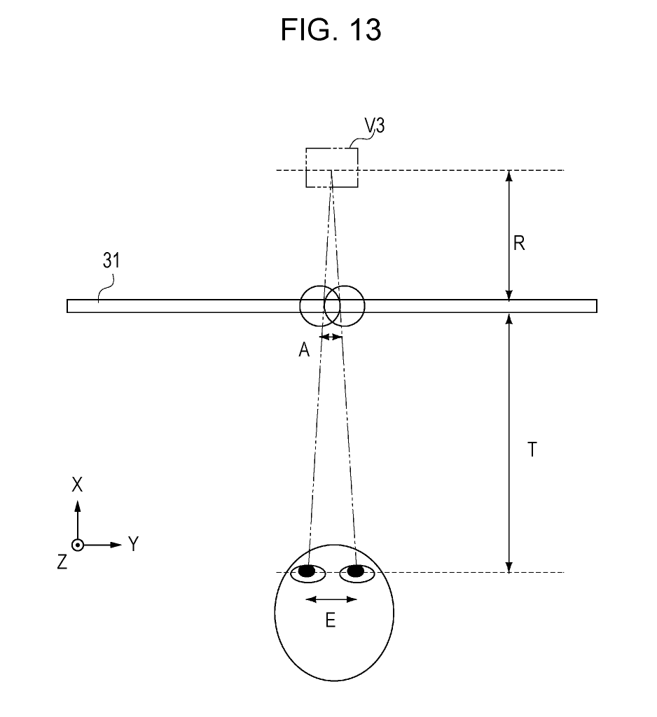

The travel display of the three dimensional video image V3 along the depth direction of the screen is enabled by associating a motion of a finger on the detection surface 11 with the parallax of a video image displayed on the screen 31. For example, as shown in FIG. 13, when the distance (viewing distance) between the user and the screen 31 is defined as T, the video image parallax of the video image V3 as A, the distance between the eyes as E, and the depth of the video image as R, there are the relationship below in the T, A, E, and R.

R:A=(R+T):E

A=(R×E)/(R+T) (13)

As an example, in a case of intending to show such that the video image V3 is displayed at a position 24 m back (R=24 m) in the screen 31 where E=65 mm and T=2 m, the magnitude of the video image parallax A becomes 6 cm, which means that the distance between a display video image for the right eye and a display video image for the left eye may be displaced by 6 cm. Accordingly, by associating this video image parallax A with the amount D of travel of a finger in the x axis direction on the detection surface 11 as

A=α·D (α is a proportional constant) (14),

it becomes possible to make the amount of travel of a finger and the three dimensional video image V3 correspond to each other. In this case, the MPU 15 of the input device 1 (or the MPU 25 of the image control device 2) generates a control signal including video image parallax information with an operational approach based on the expressions (13) and (14).

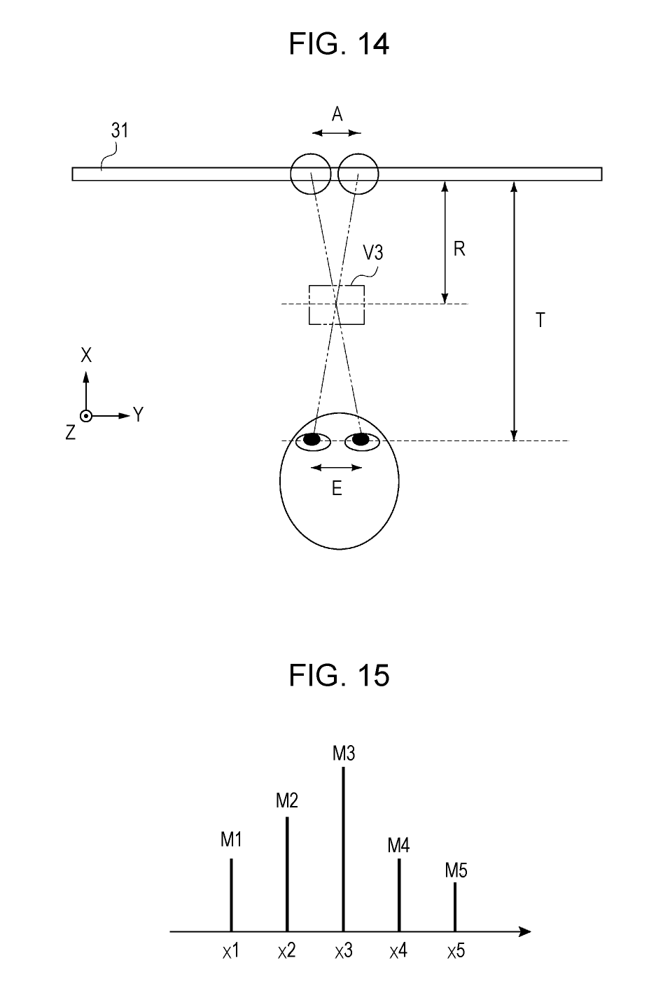

In contrast, in a case of displaying the video image V3 in the front direction of the screen 31, as shown in FIG. 14, the video image parallax A is expressed as below.

R:A=(T−R):E

A=(R×E)/(T−R) (15)

As an example, in a case of intending to show such that the video image V3 is displayed at a position 1.2 m in front (R=1.2 m) in the screen 31 where E=65 mm and T=2 m, the magnitude of the video image parallax A becomes 10 cm, which means that the distance between a display video image for the right eye and a display video image for the left eye may be displaced by 10 cm. Then, in this case as well, by associating this video image parallax A with the amount D of travel of a finger in the x axis direction on the detection surface 11 as

A=α·D (α is a proportional constant) (14),

it becomes possible to make the amount of travel of a finger and the three dimensional video image V3 correspond to each other.

As thus described, the input control system of the embodiment enables an appropriate display control of a three dimensional video image V3 along the depth direction on the screen 31. In addition, an image displayed on the screen 31 can be controlled three dimensionally by the orientation operation of the input device 1 and the travel operation of a finger on the detection surface 11, so that it is possible to obtain a user intuitive operational feeling that is high in operability.

Although embodiments of the present disclosure have been described above, embodiments of the present disclosure are not limited to them and various modifications are possible based on the technical concept of the embodiments of the present disclosure.

For example, in the above embodiments, the angle detection unit 13 is not limited to the case of being configured with the three acceleration sensors 13x, 13y, and 13z arranged along each axial direction of the input device 1 (housing 10). The acceleration sensor(s) may also be single or two in accordance with the tilt direction, the tilt angle range, and the like to be detected by the housing 10. That is, in a case of detecting the tilt angle of the housing 10 about the y axis within a range of from 0 to 90 degrees, one acceleration sensor may be arranged in the x axis direction. In another case of detecting the tilt angles of the housing 10 about the x axis and the y axis within a range of from 0 to 90 degrees, respectively, the respective acceleration sensors may be arranged in the respective directions of the x axis and the y axis.

In addition, the angle detection unit may also include an angular velocity sensor. This enables to detect a tilt angle in a desired axial direction of the housing 10 regardless of the direction of gravity. It is also possible to use the acceleration sensors and the angular velocity sensors simultaneously to use one as main sensors and the other as auxiliary sensors. Further, instead of the so-called inertial sensors, such as acceleration sensors and angular velocity sensors, geomagnetic sensors and the like may also be used. In this case, the angle detection unit can be configured using, for example, two- or three-axis geomagnetic sensors.

Further, by placing a plurality of electromagnetic or optical originating points at predetermined positions, such as corners of the screen and ground surface, the gradient of the input device may also be detected relative to the global coordinate system. This type of originating point may include, for example, a laser light source, an imaging element, and the like.

Meanwhile, centroid computation can be applied to the detection of the position coordinates of a detection object (finger) using the sensor panel 12 to improve the detection accuracy. For example, as shown in FIG. 13, where the magnitude of the signals in the wirings x1, x2, x3, x4, x5, and . . . for x position detection is defined as M1, M2, M3, M4, M5, and . . . , respectively, a general expression to obtain the centroid is expressed as follows.

Centroid position=ΣMiXi/ΣMi (16)

That in the y axis direction is also operated similarly.

By thus calculating the centroids of an x axis signal and a y axis signal, the position coordinates of a finger are calculated.

The present disclosure contains subject matter related to that disclosed in Japanese Priority Patent Application JP 2010-232469 filed in the Japan Patent Office on Oct. 15, 2010, the entire contents of which are hereby incorporated by reference.

What is claimed is:

1. An input device, comprising:
a housing having a two dimensional detection surface;
a first detection unit detecting a position coordinate of a detection object that travels on the detection surface and outputting a first signal to calculate a travel direction and an amount of travel of the detection object;
a second detection unit detecting gradient of the detection surface relative to one reference plane in a spatial coordinate system to which a screen belongs and outputting a second signal to calculate a tilt angle of the detection surface relative to the reference plane; and
a control unit generating a control signal to three dimensionally control a display of an image displayed on the screen based on the first signal and the second signal.

2. The input device according to claim 1, wherein
the detection surface has a first axis and a second axis orthogonal to the first axis, and
the second detection unit includes an acceleration sensor outputting a signal corresponding to a tilt angle for an axial direction of at least one of the first axis and the second axis relative to a direction of gravity.

3. The input device according to claim 2, wherein the image is a pointer to indicate a three dimensional video image displayed on the screen.

4. The input device according to claim 2, wherein
the image is a three dimensional video image displayed on the screen, and
the control signal includes a signal controlling magnitude of video image parallax of the three dimensional video image.

5. The input device according to claim 1, further comprising:
a switch generating a third signal by being provided in the housing and being press operated; wherein
the control unit generates a second control signal to select an image displayed on the screen based on the third signal.

6. The input device according to claim 1, wherein the first detection unit includes a capacitive sensor statically detecting a position of the detection object proximity to the detection surface.

7. An input control system, comprising:
an input device having a housing that has a two dimensional detection surface, a first detection unit that detects a position coordinate of a detection object travelling on the detection surface and that outputs a first signal to calculate a travel direction and an amount of travel of the detection object, a second detection unit that detects a tilt angle of the detection surface relative to one reference plane in a spatial coordinate system to which a screen belongs and that outputs a second signal to calculate the tilt angle of the detection surface relative to the reference plane, and a sending unit sending the first signal and the second signal; and
an information processing device having a receiving unit that receives the first signal and the second signal sent from the sending unit, and a control unit that generates a control signal to three dimensionally control a display of an image displayed on the screen based on the first signal and the second signal.

8. A method of processing information, comprising:
calculating, based on an output of a first detection unit detecting a position coordinate of a detection object travelling on a two dimensional detection surface, a travel direction and an amount of travel of the detection object;
calculating, based on an output of a second detection unit detecting gradient of the detection surface relative to one reference plane in a spatial coordinate system to which a screen belongs, a tilt angle of the detection surface relative to the reference plane; and
three dimensionally controlling, based on the travel direction and the amount of travel of the detection object and the tilt angle of the detection surface relative to the reference plane, a display of an image displayed on the screen.

9. A program making an information processing device execute a process comprising:
calculating, based on an output of a first detection unit detecting a position coordinate of a detection object travelling on a two dimensional detection surface, a travel direction and an amount of travel of the detection object;
calculating, based on an output of a second detection unit detecting gradient of the detection surface relative to one reference plane in a spatial coordinate system to which a screen belongs, a tilt angle of the detection surface relative to the reference plane; and
three dimensionally controlling, based on the travel direction and the amount of travel of the detection object and the tilt angle of the detection surface relative to the reference plane, a display of an image displayed on the screen.
